(19) United States
(12) Patent Application Publication
(10) Pub. No.: US 2014/0253759 A1
(43) Pub. Date: Sep. 11, 2014

(54) PIXEL-BASED DIRECTIONAL PREDICTION PATTERNS FOR DIGITAL CODING OF IMAGES

(71) Applicant: SONY CORPORATION, Tokyo (JP)

(72) Inventors: Mohammad Gharavi-Alkhansari, San Jose, CA (US); Wei Liu, San Jose, CA (US)

(73) Assignee: SONY CORPORATION, Tokyo (JP)

(21) Appl. No.: 13/793,041

(22) Filed: Mar. 11, 2013

(51) Int. Cl. G06T 9/00

(52) U.S. Cl. CPC G06T 9/004
USPC 348/231.99; 382/166

(57) ABSTRACT

Pixel-based prediction patterns for YUV and RGB data for compression of digital images are described herein. The prediction patterns contain eight directional predictions (right right up, right up, right up up, up, left up up, left up, left left up and left) and one non-directional (DC) prediction. Prediction for each color component is performed using samples only from the same color component but at a different position. DC prediction corresponds to averaging 4 or 8 pixels in the previous line of the current sample.

### FIELD OF THE INVENTION

The present invention relates to the field of image processing. More specifically, the present invention relates to intra prediction.

### BACKGROUND OF THE INVENTION

Many image compression systems rely heavily on prediction method. The performance of such systems depends largely on the quality of the prediction technique.

### SUMMARY OF THE INVENTION

Pixel-based prediction patterns for YUV and RGB data for compression of digital images are described herein. First, an image is partitioned into blocks. In each block, for the purpose of compression, all of the pixels in the block use one of nine possible prediction patterns. This prediction pattern is the same for all of the pixels in one block, but are able to change from one block to another by proper signaling. In each block, the order of processing of the pixels is in raster scan order, from left to right, and from top to bottom. The prediction patterns contain eight directional predictions (right right up, right up, right up up, up, left up up, left up, left left up and left) and one non-directional (DC) prediction. Prediction for each color component is performed using samples only from the same color component but at a different position. DC prediction corresponds to averaging 4 or 8 pixels in the previous line of the current sample.

In one aspect, a method of intra prediction for compression programmed in a controller of a device comprises partitioning an image into one or more blocks and encoding the one or more blocks using a prediction pattern, wherein prediction for each color component uses a sample from a same color component at a different position. The method further comprises acquiring the image. The prediction pattern is for Y, U, V in YUV444, and R, G, B in RGB images. The prediction pattern is for U and V in 4:2:2. The prediction pattern is for U and V in 4:2:0. Prediction modes of the prediction include at least one of: DC, right right up, right up, right up up, up, left up up, left up, left left up and left. The method wherein the right right up direction uses a first pixel two positions to the right and one position up, the right up direction uses a second pixel one position to the right and one position up, the up direction uses a third pixel one position up, the right up up direction uses a calculation with the second pixel and the third pixel, the left up direction uses a fourth pixel one position to the left and one position up, the left up up direction uses a second calculation with the third pixel and the fourth pixel, the left left up direction uses a fifth pixel two positions to the left and one position up and the left direction uses a sixth pixel one position to the left. The device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a system for image compression programmed in a controller in a device comprises a partitioning module configured for partitioning an image into one or more blocks and an encoding module configured for encoding the one or more blocks using a prediction pattern, wherein prediction for each color component uses a sample from a same color component at a different position. The system further comprises acquiring the image. The prediction pattern is for Y, U, V in YUV444 images, and R, G, B in RGB images. The prediction pattern is for U and V in 4:2:2. The prediction pattern is for U and V in 4:2:0. Prediction modes of the prediction include at least one of: DC, right right up, right up, right up up, up, left up up, left up, left left up and left. The system wherein the right right up direction uses a first pixel two positions to the right and one position up, the right up direction uses a second pixel one position to the right and one position up, the up direction uses a third pixel one position up, the right up up direction uses a calculation with the second pixel and the third pixel, the left up direction uses a fourth pixel one position to the left and one position up, the left up up direction uses a second calculation with the third pixel and the fourth pixel, the left left up direction uses a fifth pixel two positions to the left and one position up and the left direction uses a sixth pixel one position to the left. The device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a camera device comprises a video acquisition component for acquiring a video, a memory for storing an application, the application for: partitioning an image into one or more blocks and encoding the one or more blocks using a prediction pattern, wherein prediction for each color component uses a sample from a same color component at a different position and a processing component coupled to the memory, the processing component configured for processing the application. The prediction pattern is for Y, U, V in YUV444 images, and R, G, B in RGB images. The prediction pattern is for U and V in 4:2:2. The prediction pattern is for U and V in 4:2:0. Prediction modes of the prediction include at least one of: DC, right right up, right up, right up up, up, left up up, left up, left left up and left. The camera device wherein the right right up direction uses a first pixel two positions to the right and one position up, the right up direction uses a second pixel one position to the right and one position up, the up direction uses a third pixel one position up, the right up up direction uses a calculation with the second pixel and the third pixel, the left up direction uses a fourth pixel one position to the left and one position up, the left up up direction uses a second calculation with the third pixel and the fourth pixel, the left left up direction uses a fifth pixel two positions to the left and one position up and the left direction uses a sixth pixel one position to the left.

### BRIEF DESCRIPTION OF THE DRAWINGS

FIG. 1 illustrates a prediction pattern according to some embodiments.

FIG. 2 illustrates a prediction pattern according to some embodiments.

FIG. 3 illustrates a prediction pattern according to some embodiments.

FIG. 4 illustrates a flowchart of a method of performing intra prediction for compression of data according to some embodiments.

FIG. 5 illustrates a block diagram of an exemplary computing device configured to implement the intra prediction for compression of data method according to some embodiments.

### DETAILED DESCRIPTION OF THE PREFERRED EMBODIMENT

Pixel-based prediction patterns for YUV and RGB data for compression of digital images are described herein. The prediction patterns contain eight directional predictions (right right up, right up, right up up, up, left up up, left up, left left up and left) and one non-directional (DC) prediction. Prediction for each color component is performed using samples only from the same color component but at a different position. DC prediction corresponds to averaging 4 or 8 pixels in the previous line of the current sample.

The prediction patterns described herein are applicable to the methods and systems described in U.S. patent application Ser. No. 13/035,060, filed on Feb. 25, 2011, titled “A METHOD FOR COMPRESSION OF DIGITAL IMAGES USING A FIXED NUMBER OF BITS PER BLOCK” which is herein incorporated by reference in its entirety.

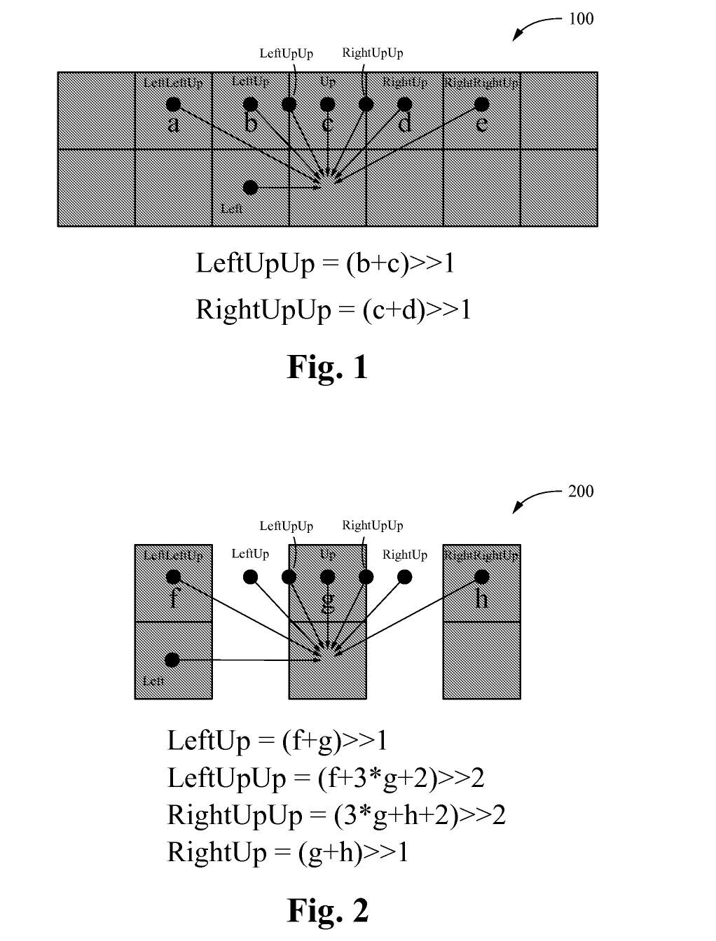

FIG. 1 illustrates a prediction pattern according to some embodiments. The prediction pattern 100 is usable for Y, U, V in YUV444 images, and R, G, B in RGB images. The various directional modes are able to be used to predict the pixel as shown in 100. The Left prediction uses a pixel one position to the left of pixel X. The LeftLeftUp prediction uses a pixel two positions to the left and one position up. The LeftUp prediction uses a pixel one position to the left and one position up. The LeftUpUp prediction uses an average of a pixel one position to the left and one position up and a second pixel one position up. The Up prediction uses a pixel one position up. The RightUpUp prediction uses an average of a pixel one position up and a second pixel one position to the right and one position up. The RightUp prediction uses a pixel one position to the right and one position up. The RightRightUp prediction uses a pixel two positions to the right and one position up. The arrows that initiate from the center of a square represent prediction from that pixel, and arrows that initiate from in between two squares, represent prediction using averaging as specified by the formulas.

FIG. 2 illustrates a prediction pattern according to some embodiments. The prediction pattern 200 is usable for U and V in YUV 4:2:2. The various directional modes are able to be used to predict the pixel as shown in 200. The Left prediction uses a pixel one position to the left of pixel X. The LeftLeftUp prediction uses a pixel one position to the left and one position up. The LeftUp prediction uses an equation of (f+g)>>1. The LeftUpUp prediction uses an equation of (f+3*g+2)>>2. The Up prediction uses a pixel one position up. The RightUpUp prediction uses an equation of (3*g+h+2)>>2. The RightUp prediction uses an equation (g+h)>>1. The RightRightUp prediction uses a pixel one position to the right and one position up.

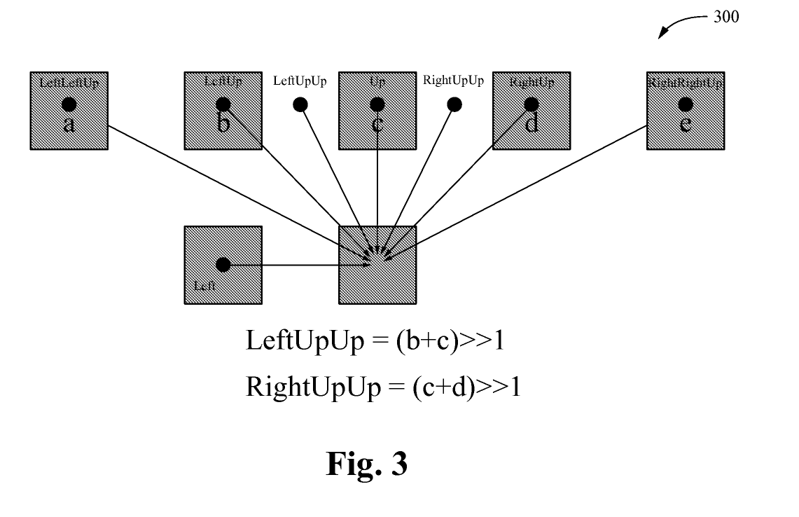

FIG. 3 illustrates a prediction pattern according to some embodiments. The prediction pattern 300 is usable for U and V in YUV 4:2:0. The various directional modes are able to be used to predict the pixel as shown in 300. The Left prediction uses a pixel one position to the left of pixel X. The LeftLeftUp prediction uses a pixel two positions to the left and one position up. The LeftUp prediction uses a pixel one position to the left and one position up. The LeftUpUp prediction uses an equation of (b+c)>>1. The Up prediction uses a pixel one position up. The RightUpUp prediction uses an equation of (c+d)>>1. The RightUp prediction uses a pixel one position to the right and one position up. The RightRightUp prediction uses a pixel two positions to the right and one position up.

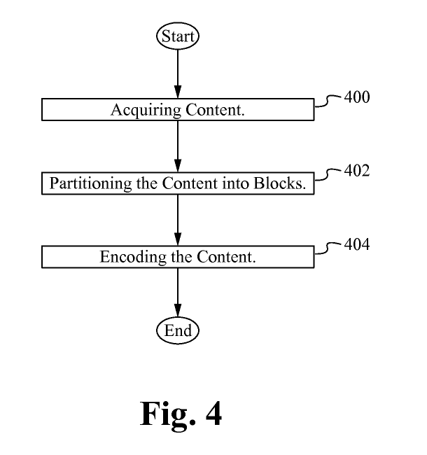

FIG. 4 illustrates a flowchart of a method of performing intra prediction for compression of data according to some embodiments. In the step 400, content (e.g., an image or a video) is acquired. In the step 402, the content is partitioned into blocks. In the step 404, the content is encoded using one or more prediction patterns. In some embodiments, fewer or additional steps are implemented. In some embodiments, the order of the steps is able to be modified.

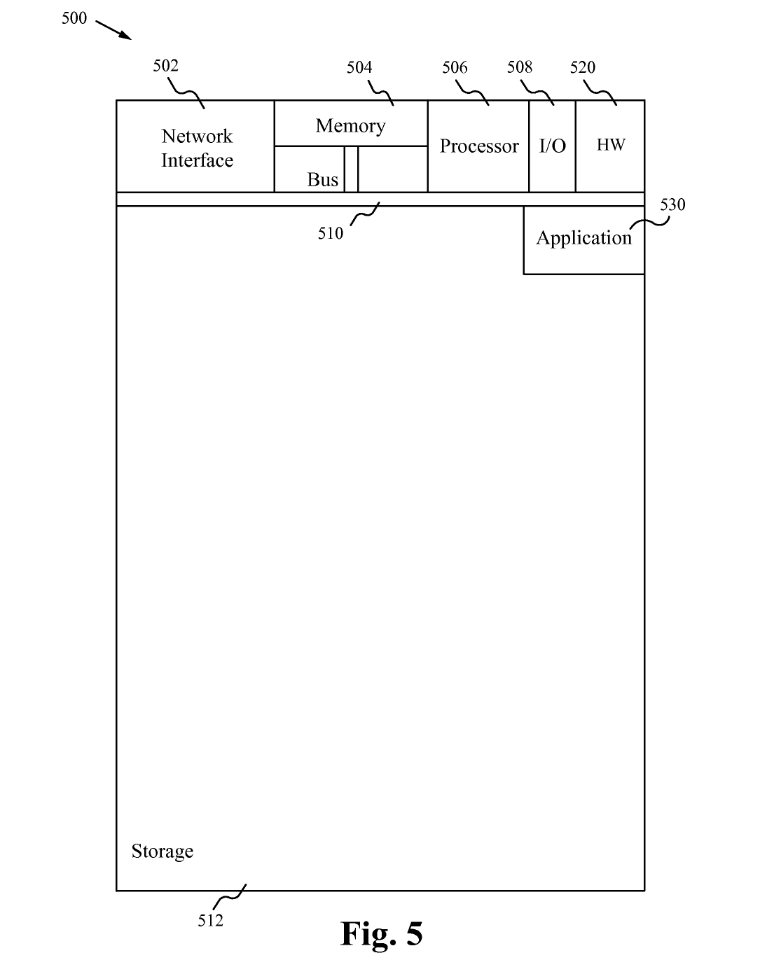

FIG. 5 illustrates a block diagram of an exemplary computing device 500 configured to implement the intra prediction for compression of data method according to some embodiments. The computing device 500 is able to be used to acquire, store, compute, communicate and/or display information such as images and videos. For example, a computing device 500 is able to acquire and store an image. The intra prediction for compression of data method is able to be used when acquiring or viewing an image on the device 500. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. Intra prediction for compression of data application(s) 530 used to perform the intra prediction for compression of data method are likely to be stored in the storage device 512 and memory 504 and processed as applications are typically processed. More or less components shown in FIG. 5 are able to be included in the computing device 500. In some embodiments, intra prediction for compression of data hardware 520 is included. Although the computing device 500 in FIG. 5 includes applications 530 and hardware 520 for intra prediction for compression of data, the intra prediction for compression of data method is able to be implemented on a computing device in hardware, firmware, software or any combination thereof. For example, in some embodiments, the intra prediction for compression of data applications 530 are programmed in a memory and executed using a processor. In another example, in some embodiments, the intra prediction for compression of data hardware 520 is programmed hardware logic including gates specifically designed to implement the image compression method.

In some embodiments, the intra prediction for compression of data application(s) 530 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

To utilize the intra prediction for compression of data method, a user acquires a video/image such as on a digital camcorder, and while or after the video is acquired, the intra prediction for compression of data method automatically compresses the data. The intra prediction for compression of data method occurs automatically without user involvement.

In operation, the intra prediction for compression of data method described herein provides image compression with a low hardware cost (e.g. not many logic gates are needed) in some embodiments, low complexity, low delay and very high visual quality (e.g. visually lossless). The intra prediction for compression of data method is able to be used in any implementation including, but not limited to, wireless high definition (Wireless HD).

### Some Embodiments of Pixel-Based Directional Prediction Patterns for Digital Coding of Images

1. A method of intra prediction for compression programmed in a controller of a device comprising:
   a. partitioning an image into one or more blocks; and
   b. encoding the one or more blocks using a prediction pattern, wherein prediction for each color component uses a sample from a same color component at a different position.
2. The method of clause 1 further comprising acquiring the image.
3. The method of clause 1 wherein the prediction pattern is for Y, U, V in YUV444 images, and R, G, B in RGB images.
4. The method of clause 1 wherein the prediction pattern is for U and V in 4:2:2.
5. The method of clause 1 wherein the prediction pattern is for U and V in 4:2:0.
6. The method of clause 1 wherein prediction modes of the prediction include at least one of:
   a. DC;
   b. right right up;
   c. right up;
   d. right up up;
   e. up;
   f. left up up;
   g. left up;
   h. left left up; and
   i. left.
7. The method of clause 6 wherein:
   i. the right right up direction uses a first pixel two positions to the right and one position up;
   ii. the right up direction uses a second pixel one position to the right and one position up;
   iii. the up direction uses a third pixel one position up;
   iv. the right up up direction uses a calculation with the second pixel and the third pixel;
   v. the left up direction uses a fourth pixel one position to the left and one position up;
   vi. the left up up direction uses a second calculation with the third pixel and the fourth pixel;
   vii. the left left up direction uses a fifth pixel two positions to the left and one position up; and
   viii. the left direction uses a sixth pixel one position to the left.
8. The method of clause 1 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
9. A system for image compression programmed in a controller in a device comprising:
   a. a partitioning module configured for partitioning an image into one or more blocks; and
   b. an encoding module configured for encoding the one or more blocks using a prediction pattern, wherein prediction for each color component uses a sample from a same color component at a different position.
10. The system of clause 9 further comprising acquiring the image.
11. The system of clause 9 wherein the prediction pattern is for Y, U, V in YUV444 images, and R, G, B in RGB images.
12. The system of clause 9 wherein the prediction pattern is for U and V in 4:2:2.
13. The system of clause 9 wherein the prediction pattern is for U and V in 4:2:0.
14. The system of clause 9 wherein prediction modes of the prediction include at least one of:
   a. DC;
   b. right right up;
   c. right up;
   d. right up up;
   e. up;
   f. left up up;
   g. left up;
   h. left left up; and
   i. left.
15. The system of clause 14 wherein:
   i. the right right up direction uses a first pixel two positions to the right and one position up;
   ii. the right up direction uses a second pixel one position to the right and one position up;
   iii. the up direction uses a third pixel one position up;
   iv. the right up up direction uses a calculation with the second pixel and the third pixel;
   v. the left up direction uses a fourth pixel one position to the left and one position up;
   vi. the left up up direction uses a second calculation with the third pixel and the fourth pixel;
   vii. the left left up direction uses a fifth pixel two positions to the left and one position up; and
   viii. the left direction uses a sixth pixel one position to the left.
16. The system of clause 9 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
17. A camera device comprising:
   a. a video acquisition component for acquiring a video;
   b. a memory for storing an application, the application for:
      i. partitioning an image into one or more blocks; and
      ii. encoding the one or more blocks using a prediction pattern, wherein prediction for each color component uses a sample from a same color component at a different position; and
   c. a processing component coupled to the memory, the processing component configured for processing the application.
18. The camera device of clause 17 wherein the prediction pattern is for Y, U, V in YUV444 images, and R, G, B in RGB images.
19. The camera device of clause 17 wherein the prediction pattern is for U and V in 4:2:2.
20. The camera device of clause 17 wherein the prediction pattern is for U and V in 4:2:0.
21. The camera device of clause 17 wherein prediction modes of the prediction include at least one of:
   a. DC;
   b. right right up;
   c. right up;
   d. right up up;
   e. up;
   f. left up up;
   g. left up;
   h. left left up; and
   i. left.
22. The camera device of clause 21 wherein:
   i. the right right up direction uses a first pixel two positions to the right and one position up;
   ii. the right up direction uses a second pixel one position to the right and one position up;
   iii. the up direction uses a third pixel one position up;
   iv. the right up up direction uses a calculation with the second pixel and the third pixel;
   v. the left up direction uses a fourth pixel one position to the left and one position up;
   vi. the left up up direction uses a second calculation with the third pixel and the fourth pixel;
   vii. the left left up direction uses a fifth pixel two positions to the left and one position up; and
   viii. the left direction uses a sixth pixel one position to the left.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of intra prediction for compression programmed in a controller of a device comprising:
a. partitioning an image into one or more blocks; and
b. encoding the one or more blocks using a prediction pattern, wherein prediction for each color component uses a sample from a same color component at a different position.

2. The method of claim 1 further comprising acquiring the image.

3. The method of claim 1 wherein the prediction pattern is for Y, U, V in YUV444 images, and R, G, B in RGB images.

4. The method of claim 1 wherein the prediction pattern is for U and V in 4:2:2.

5. The method of claim 1 wherein the prediction pattern is for U and V in 4:2:0.

6. The method of claim 1 wherein prediction modes of the prediction include at least one of:
a. DC;
b. right right up;
c. right up;
d. right up up;
e. up;
f. left up up;
g. left up;
h. left left up; and
i. left.

7. The method of claim 6 wherein:
i. the right right up direction uses a first pixel two positions to the right and one position up;
ii. the right up direction uses a second pixel one position to the right and one position up;
iii. the up direction uses a third pixel one position up;
iv. the right up up direction uses a calculation with the second pixel and the third pixel;
v. the left up direction uses a fourth pixel one position to the left and one position up;
vi. the left up up direction uses a second calculation with the third pixel and the fourth pixel;
vii. the left left up direction uses a fifth pixel two positions to the left and one position up; and
viii. the left direction uses a sixth pixel one position to the left.

8. The method of claim 1 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

9. A system for image compression programmed in a controller in a device comprising:
a. a partitioning module configured for partitioning an image into one or more blocks; and
b. an encoding module configured for encoding the one or more blocks using a prediction pattern, wherein prediction for each color component uses a sample from a same color component at a different position.

10. The system of claim 9 further comprising acquiring the image.

11. The system of claim 9 wherein the prediction pattern is for Y, U, V in YUV444 images, and R, G, B in RGB images.

12. The system of claim 9 wherein the prediction pattern is for U and V in 4:2:2.

13. The system of claim 9 wherein the prediction pattern is for U and V in 4:2:0.

14. The system of claim 9 wherein prediction modes of the prediction include at least one of:
a. DC;
b. right right up;
c. right up;
d. right up up;
e. up;
f. left up up;
g. left up;
h. left left up; and
i. left.

15. The system of claim 14 wherein:
i. the right right up direction uses a first pixel two positions to the right and one position up;
ii. the right up direction uses a second pixel one position to the right and one position up;
iii. the up direction uses a third pixel one position up;
iv. the right up up direction uses a calculation with the second pixel and the third pixel;
v. the left up direction uses a fourth pixel one position to the left and one position up;
vi. the left up up direction uses a second calculation with the third pixel and the fourth pixel;
vii. the left left up direction uses a fifth pixel two positions to the left and one position up; and
viii. the left direction uses a sixth pixel one position to the left.

16. The system of claim 9 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

17. A camera device comprising:
a. a video acquisition component for acquiring a video;
b. a memory for storing an application, the application for:
i. partitioning an image into one or more blocks; and
ii. encoding the one or more blocks using a prediction pattern, wherein prediction for each color component uses a sample from a same color component at a different position; and
c. a processing component coupled to the memory, the processing component configured for processing the application.

18. The camera device of claim 17 wherein the prediction pattern is for Y, U, V in YUV444 images, and R, G, B in RGB images.

19. The camera device of claim 17 wherein the prediction pattern is for U and V in 4:2:2.

20. The camera device of claim 17 wherein the prediction pattern is for U and V in 4:2:0.

21. The camera device of claim 17 wherein prediction modes of the prediction include at least one of:
a. DC;
b. right right up;
c. right up;
d. right up up;
e. up;
f. left up up;
g. left up;
h. left left up; and
i. left.

22. The camera device of claim 21 wherein:
i. the right right up direction uses a first pixel two positions to the right and one position up;
ii. the right up direction uses a second pixel one position to the right and one position up;
iii. the up direction uses a third pixel one position up;
iv. the right up up direction uses a calculation with the second pixel and the third pixel;
v. the left up direction uses a fourth pixel one position to the left and one position up;
vi. the left up up direction uses a second calculation with the third pixel and the fourth pixel;
vii. the left left up direction uses a fifth pixel two positions to the left and one position up; and
viii. the left direction uses a sixth pixel one position to the left.
